(19) United States
(12) Patent Application Publication
(10) Pub. No.: US 2006/0247047 A1
(43) Pub. Date: Nov. 2, 2006

(54) Universal button module

(76) Inventors: Michael J. Mitchell, Las Vegas, NV (US); Robert A. Luciano JR., Reno, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/106,212

(22) Filed: Apr. 14, 2005

(51) Int. Cl. A63F 13/00

(52) U.S. Cl. 463/37

(57) ABSTRACT

The present invention relates to a universal button module for use in connection with a machine, including a gaming machine. The universal button module is adaptable to perform particular functions in gaming machines such as controlling the selection of the number of pay lines to play or the number of credits to bet per pay line. Additionally, the universal button module comprises a display for outputting information.

### BACKGROUND

Current gaming machines have hardwired pre-configured button panels that correspond to particular games offered for play on the gaming machine. The pre-configured button panels provide the appropriate amount of buttons needed to properly operate the provided games on the gaming machine. For example, if a game requires the use of three buttons to play the game, the button panel will typically have at least three buttons.

To function properly, any new games placed on a gaming machine must be compatible with the pre-configured traditional button panel system. Otherwise, the panel must be physically changed. For example, if a new game requires the use of twelve buttons to play the game and the gaming machine has a button panel with only six buttons, the new game will generally not function properly with the existing gaming machine button panel. As a result, the button panel will require a physical change or the new game will not be able to be played effectively on the gaming machine.

Additionally, in current gaming systems, the buttons are designed to perform a particular function. In games having multiple pay lines, buttons are provided to enable a user to select a particular number of pay lines. Generally, gaming machines provide button panels with a set of hard-wired buttons that are associated with a particular function. For example, in a game offering six pay lines, the gaming machine will typically have a button panel with a set of buttons representing a range of values for selecting the number of pay lines to bet. This hard-wired button panel, however, will not necessarily work well with other games. If a new game offering ten pay lines is placed on the gaming machine there will not be enough buttons to enable every number of pay lines to be bet. Thus, having the capability of activating or selecting any number of the pay lines would require physically changing the button panel and adding more buttons.

Alternatively, other new games added to a gaming machine might require different physical changes to the button panel such as re-labeling the button caps rather than changing the actual number of buttons on the button panel.

Physically changing and altering the buttons on a button panel can be a time-consuming and costly process. What is needed is a button system that may be adapted for use in a plurality of gaming systems without requiring substantial or major physical modification of the button panel.

Additionally, in multi-denominational machines a player may select whether a credit is worth a penny, a nickel, a quarter, a dollar, etc. It is undesirable to use the same math model for a penny game as for a $5 game. A penny game might offer a 92% return and a $5 game might offer a 98% return. Accordingly, as a player makes a denomination selection, gaming machines typically switch to a math model that corresponds to that selection. The same game title and theme are used but the wagering options change. The machine generally loads a separate version of the game already resident on the machine. Generally speaking, the higher the denomination, the fewer the pay lines that are offered. A $1 game might only offer 3 or 5 lines at 5-10 credits per line. Whereas, a ½ cent game might offer 20 lines at 20 credits per line.

These radical differences in betting options make it difficult to maintain the same fixed button labeling patterns on the wagering rows across all math models. The more credits available for wagering, the bigger the holes become in the bet patterns.

Reducing the number of pay lines as a player switches to a higher denomination can lead to fewer usable buttons on the button deck. Unusable buttons lead to player confusion.

What is needed is a button system that simplifies the player controls by reducing the number of buttons and does not require the physical modification of the labels on the controls as different games are played.

### SUMMARY

Briefly, and in general terms, various embodiments of a universal button module are disclosed herein. One embodiment is directed to a gaming machine comprising a cabinet having a game display, a playing deck, one or more games having one or more pay lines, and one or more universal button modules. The universal button module controls the selection of the number of pay lines to play in a game or the number of credits to bet per pay line in a game.

In another embodiment, the universal button module is for use in connection with a gaming machine. The universal button module comprises a first button portion for increasing the number of pay lines to play or the number of credits to bet per pay line, and a second button portion for decreasing the number of pay lines to play or the number of credits to bet per pay line. Additionally, the universal button module comprises a display for outputting information.

Alternatively, another embodiment is directed to a universal button module for use in connection with any machine. The types of machine may include an automated teller machine, a vending machine, a gaming machine, or any other machine that uses buttons. The universal button module comprises a first button portion for controlling a first function in connection with the machine, and a second button portion for controlling a second function in connection with the machine. Additionally, the universal button module comprises a display for outputting information.

### BRIEF DESCRIPTION OF THE DRAWINGS

FIG. 1 is an illustration of a gaming machine comprising an embodiment of a universal button module.

FIG. 2 is an illustration of an embodiment of a universal button module for use in a gaming system.

FIG. 3 is an illustration of an embodiment of a universal button module on a gaming machine.

FIG. 4 is an illustration of an embodiment of a universal button module for use in a gaming system.

FIG. 5 is an illustration of an embodiment of a universal button module for use in a gaming system.

FIG. 6 is an illustration of an embodiment of a universal button module for use in a gaming system.

FIG. 7 is an illustration of a gaming machine comprising an embodiment of a universal button module.

FIG. 8 is an illustration of a gaming machine comprising an embodiment of a universal button module.

FIG. 9 is an illustration of additional forms of universal button modules.

FIG. 10 is an illustration of an embodiment of a universal button module.

FIG. 11 is an illustration of an embodiment of a universal button module.

FIG. 12 is an illustration of an embodiment of a universal button module.

FIG. 13 is an illustration of an embodiment of a universal button module.

### DETAILED DESCRIPTION

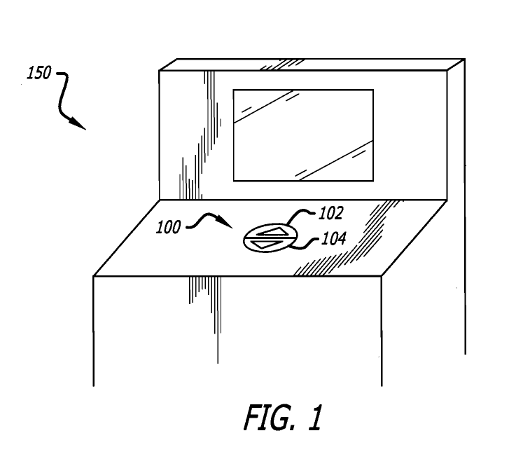

Various embodiments are directed to a universal button module for use with a plurality of different gaming systems. More particularly, the universal button module provides a dynamic button system adaptable for use with various games and capable of adjusting to gaming systems having frequent game changes. The adaptability of the universal button module alleviates the costly and time consuming process of having to physically change the button panels when new games are added to or changed within a gaming machine. Embodiments of the system and method are illustrated and described herein, by way of example only, and not by way of limitation. Referring now to the drawings, wherein like reference numerals denote like or corresponding parts throughout the drawings and, more particularly to FIGS. 1-13, there is shown a universal button module.

In one embodiment, the universal button module has the capability and functionality to be used with a multitude of games. Referring now to FIG. 1, a universal button module 100 for use in connection with a gaming machine 150 is illustrated. The universal button module 100 comprises a first button portion 102 for incrementing a value and a second button portion 104 for decrementing a value. The universal button module 100 may be used in connection with playing a game on the gaming machine 150, wherein the game has a set number of pay lines. In this example, the universal button module is used to select a number of pay lines to play in the game. A user may select to play any number of pay lines ranging between a minimum value, such as one, and a maximum value (i.e. the maximum number of pay lines). The first button portion 102 is manipulated or depressed to increase the number of pay lines to be played and the second button portion 104 is manipulated or depressed to decrease the number of pay lines to be played.

In another example, the universal button module is used to select the credits wagered or bet per pay line. In this example, the first button portion 102 is manipulated or depressed to increase the number of credits to bet per pay line and the second button portion 104 is manipulated or depressed to decrease the number of credits to bet per pay line.

In one embodiment, the first button portion 102 may be tapped to incrementally increase the number of credits bet per pay line. Similarly, the second button portion 104 may be tapped to decrease the number of credits bet per play line. In an alternative embodiment, the first button portion 102 may be depressed or “held down” to gradually accelerate the increase in the number of credits bet per play line. Likewise, the second button portion 104 may be depressed or “held down” to gradually accelerate the decrease in the number of credits bet per play line.

In another embodiment, the universal button module is used in connection with a gaming machine capable of downloading gaming data. The gaming data may be downloaded via a network connection. Optionally, in an alternative embodiment, the gaming data may be downloaded on demand.

Alternatively, the gaming data may be transferred to the gaming machine via other well known data transfer means. By way of example, but not by limitation, such means include external memory devices, dongles, hard drives, cd-roms, dvds, and wireless technology.

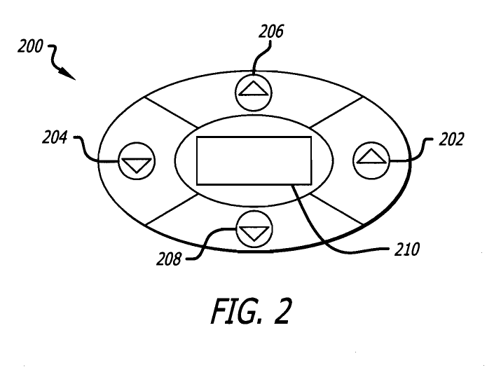

FIG. 2 illustrates an alternative embodiment of the universal button module which may also be used in connection with a gaming machine. The universal button module 200 has a first button portion 202 for incrementing a value and a second button portion 204 for decrementing a value. Additionally, the universal button module 200 has a display 210 for displaying the value selected. The universal button module 200 may be used to select the number of pay lines to play in a game. The first button portion 202 and second button portion 204 may be manipulated to obtain the desired number of pay lines to play. As the first button portion 202 and second button portion 204 are being manipulated, the current number of pay lines is displayed in the display 210. Once the desired number of pay lines is obtained, the number is selected.

The universal button module 200 may also be used to select credits to bet per pay line. The first button portion 202 and second button portion 204 may be manipulated to obtain the desired amount of the bet or wager. The display 210 shows or displays the value of the credits bet.

In one embodiment, the amount bet per pay line is the same for each pay line. In an alternate embodiment, the amount bet per pay line may vary for each pay line.

Optionally, in a separate embodiment, the universal button module 200 may be used to select particular pay lines in a game. The first button portion 202 and second button portion 204 may be manipulated to select particular pay lines. In one example of this embodiment, a game has ten pay lines and each of the ten pay lines is uniquely identified. The universal button module 200 may be used to particularly select any of the ten uniquely identified pay lines. Additionally, in an optional embodiment, a particular bet or wager may then be designated to each particularly selected pay line.

Referring back to FIG. 2, in an optional embodiment, the universal button module 200 has a third button portion 206 for selecting a maximum value and a fourth button portion 208 for selecting a minimum value. In another embodiment, where the universal button module 200 is used to select the number of pay lines to play in a game, the third button portion 206 automatically selects the maximum number of pay lines to play and the fourth button portion 208 automatically selects the minimum number of pay lines to play. In another embodiment, where the universal button module 200 is used to select the number of credits to bet per pay line, the third button portion 206 automatically selects the maximum number of credits to bet per pay line and the fourth button portion 208 automatically selects the minimum number of credits to bet per pay line. The above embodiment is not intended to limit the universal button module to four button portions, but rather is meant to serve as an illustration of one embodiment. The universal button module may have an unlimited number of button portions.

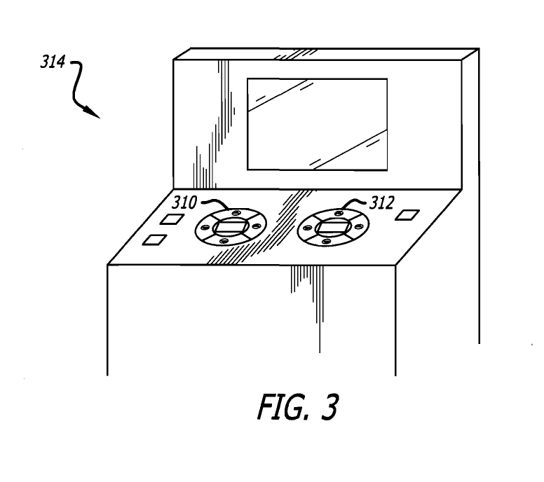

FIG. 3 shows universal button modules 310 and 312 located on a gaming machine 314. The universal button module 310 is used to select the number of pay lines to play in a game and the universal button module 312 is used to select the number of credits to bet per pay line.

As those skilled in the art will appreciate, numerous methods exist and are known for connecting buttons, lights and displays to gaming machines. Examples of some of the many connection methods are described as follows for illustrative purposes only and are not meant as a limitation. In some embodiments, the universal button modules are connected directly to the gaming machine. For example, the universal button module can be wired directly into the backplane of the gaming machine. In another embodiment, the universal button module is connected to a separate controller by a serial, parallel, USB, or any other peripheral connection. Alternatively, in a different embodiment, the universal button controller is connected to a generic device controller unit. Such a unit is disclosed in U.S. patent application Ser. No. 09/746,854, Publication No. 2002/0019891 A1, which is incorporated herein by reference. Optionally, in another embodiment, the universal button module may be connected wirelessly to the gaming machine. Additionally, in an optional embodiment where a universal button module connects wirelessly to a gaming machine, the universal button module is not physically connected to the gaming machine.

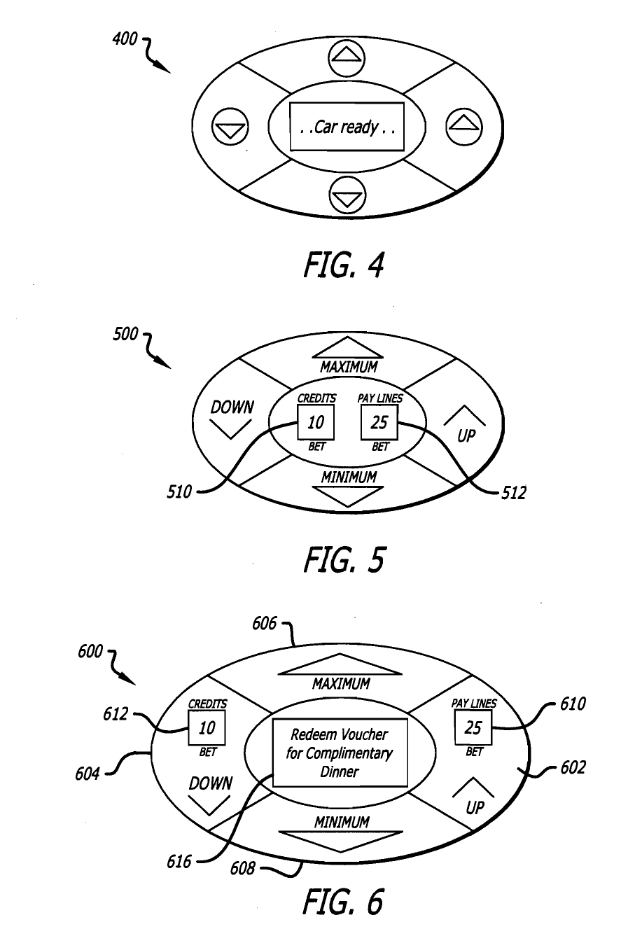

Referring back to FIG. 2, the display 210 on the universal button module 200 may comprise any number or type of display technologies, such as, but not limited to Light Emitting Diodes (LEDs), organic LEDs, Liquid Crystal Displays (LCDs), Vacuum Fluorescent Displays (VFDs) or any other display technologies for providing visual output to the player or to anyone using the universal button module. Such output includes, but is not limited to, the number of pay lines sought to be bet, the number of credits sought to be bet, or other text based information such as when a table is ready at a restaurant, when a car is ready for pick-up, when extra credits have been earned, promotional information, diagnostics, instant messaging from others, information for accounting audits and animated graphics. FIG. 4 illustrates a universal button module 400 displaying a textual message.

Optionally, in alternative embodiments, each universal button module can have one or more displays. FIG. 5 illustrates an example of a universal button module 500 having a display 510 and a display 512. In another embodiment, one or more displays may be found in only one of the two or more universal button modules. In still another embodiment, the universal button modules may have no displays, but may be associated with one or more displays located elsewhere on the machine. For example, the play screen on the main game may show the results of the number of pay lines selected to be played in a game or the number of credits selected to be bet in a game.

Alternatively, in another embodiment, one or more button portion may have a display. Referring now to FIG. 6, a universal button module 600 is shown. The universal button module 600 comprises button portions 602, 604, 606 and 608. Button portion 602 has a display 610 and button portion 604 has a display 612. Additionally, universal button module 600 has a display 616 for outputting textual information. FIG. 6 shows a promotional message for a complimentary dinner. However, it is understood that any type of textual information may be displayed in the display 616.

Referring back to FIG. 2, in alternative embodiments, the universal button module 200 may be used to perform functions other than selecting pay lines and credits per bet. For example, the universal button module may be used to select the speed of the game presentation, game audio volume and other player-preference options. In still other alternative embodiments, the universal button module 200 may be used by a gaming machine technician to navigate through diagnostic or accounting menus or to set gaming machine options such as, but not limited to, screen contrast, high credit meter limit and collect lockup limit.

In another embodiment, the universal button module is an intelligent module that is capable of operating in connection with a machine while operating independently from the main CPU of the machine. For example, referring back to FIG. 2, an intelligent universal button module 200 can be used in connection with a gaming machine. The universal button module 200 is capable of receiving and accepting all necessary gaming data such that it operates independently from the main CPU of the gaming machine.

In another embodiment, the universal button module is an intelligent module that receives gaming data via a downloaded game. The downloaded game contains all the required intelligence for the button to operate. Such intelligence includes, but is not limited to, determining button values, such as the maximum and minimum button values, determining button labels, textual display information, etc.

In another embodiment, the universal button module 200 may be used as an input device for the play of a bonus game. The first button portion 202 and the second button portion 204 may be manipulated in some fashion to control and play a bonus game offered for play on a gaming machine. Alternatively, in yet another embodiment, the universal button module 200 may be used to move a cursor around on a display screen and to make a selection.

Additionally, in an optional embodiment, two or more universal button modules may be used in combination to provide additional actions and/or functionality. For example, simultaneously pushing the two top buttons from two different universal button modules can initiate a max bet on all pay lines, lock-in credits for each pay line one at a time, or activate an additional function or feature.

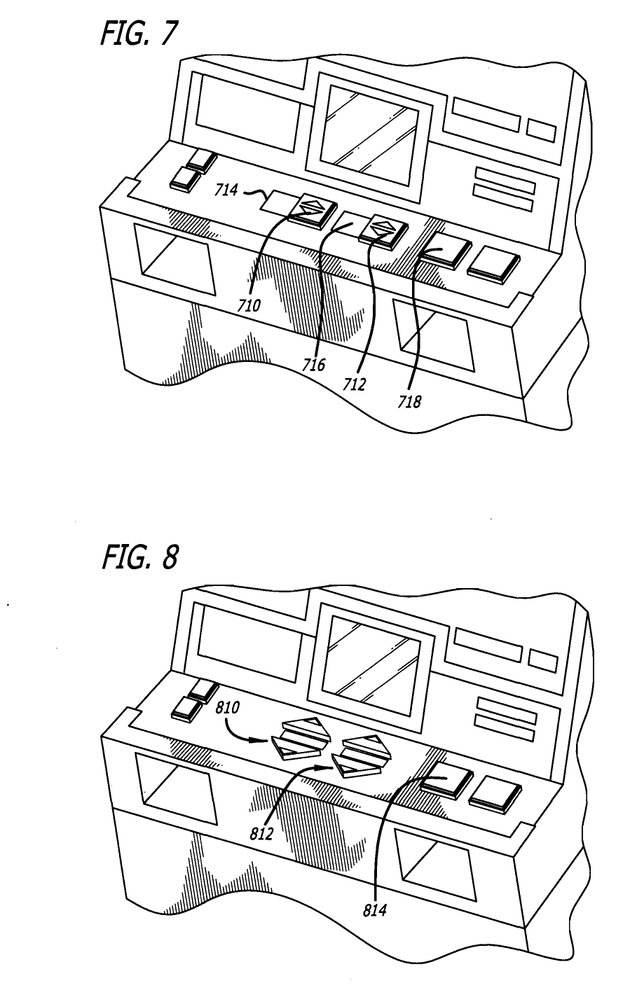

Additionally, the universal button module can vary in size and shape to maximize the look and feel of the button deck and the efficiency and functionality thereof. Referring to FIG. 7, two square universal button modules are illustrated. Specifically, square universal button modules 710 and 712 are shown. Additionally, displays 714 and 716 are adjacent to each of the respective universal button modules 710 and 712. Also, a max bet button 718 is located separate from the universal button modules. Activation of the max bet button 718 automatically sets the wager as the maximum bet amount.

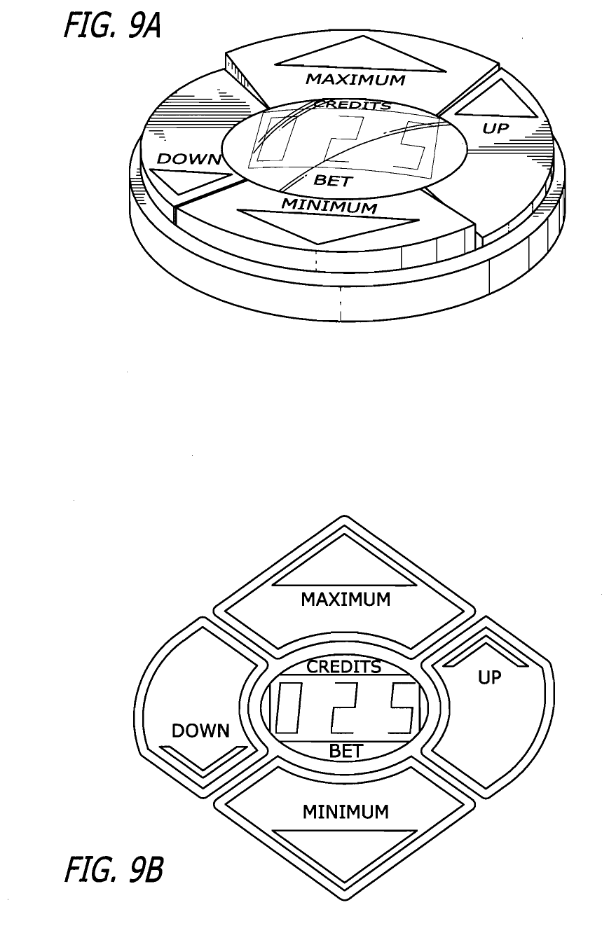

In another embodiment, as shown in FIG. 8, portions of the universal button modules 810 and 812 are in the shape of a triangle. Additionally, each universal button module 810 and 812 further comprises a display in the center of the module. A max bet button 814 is located separately on the button panel.

FIG. 9 illustrates additional examples of possible shapes for use with the universal button module. As those skilled in the art will appreciate, the universal button module may have any shape such as, but not limited to, an ellipse, circle, trapezoid, rhombus, or any other polygonal or free-form shape.

In an optional embodiment, the universal button module can be lit up. The universal button module can have internal lighting, back lighting, a lit bezel or any other well known lighting technique. Additionally, the lights can consist of any color scheme and may flash or remain static. The lighting of the universal button module can be configured such that the color scheme reflects a game theme.

In another embodiment, a universal button module acts as a toggle switch. Additionally, a display may be located in the center of the universal button module and the universal button module may be rocked forward to raise the number credits, and rocked backward to lower the number of credits. Likewise, the universal button module may be rocked to the sides to implement other functions.

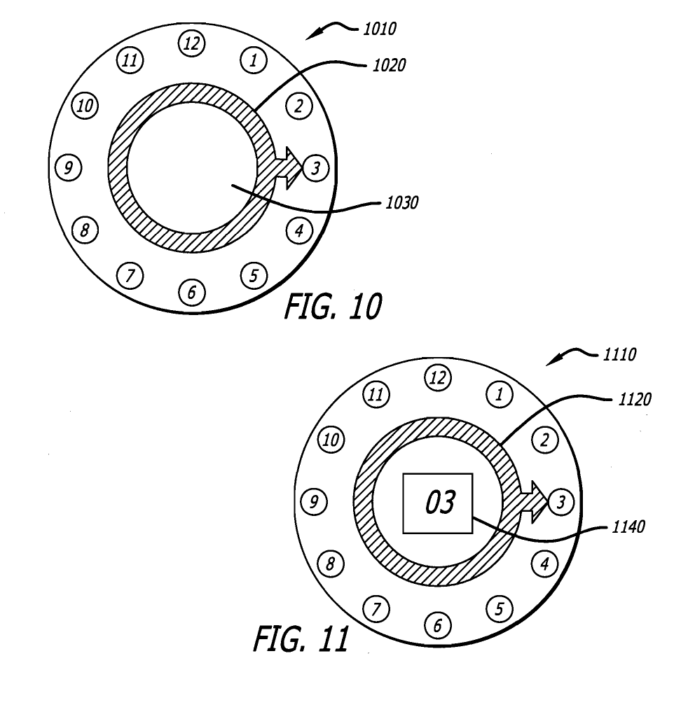

Similarly, the universal button module may be rotated to increment and decrement various functions. An example of one embodiment is shown in FIG. 10 where a universal button module 1010 in the form of a radio knob is illustrated. A knob 1020 is used to select the number of pay lines to play in a game or the number of credits to bet in a game. The center portion 1030 of the knob 1020 may be depressed to make a number selection. FIG. 11 illustrates another embodiment of a universal button module 1110 also in the form of a radio knob. A knob 1120 is used to select the number of pay lines to play in a game or the number of credits to bet in a game. A display 1140 displays the number of pay lines or credits selected. Alternatively, in a different embodiment, the display 1140 could show various other types of textual information.

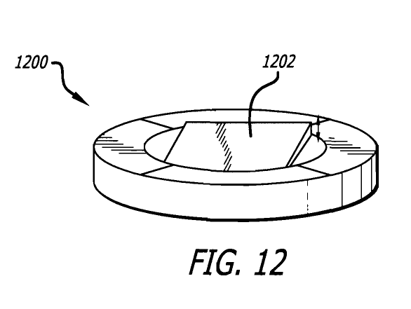

In an additional embodiment, a universal button module comprises a moveable display portion. Referring now to FIG. 12, a universal button module 1200 having a display portion 1202 is illustrated. The display portion 1202 can tilt to provide more flexibility and to adjust the angle of the display portion for easier and clearer viewing of the information displayed.

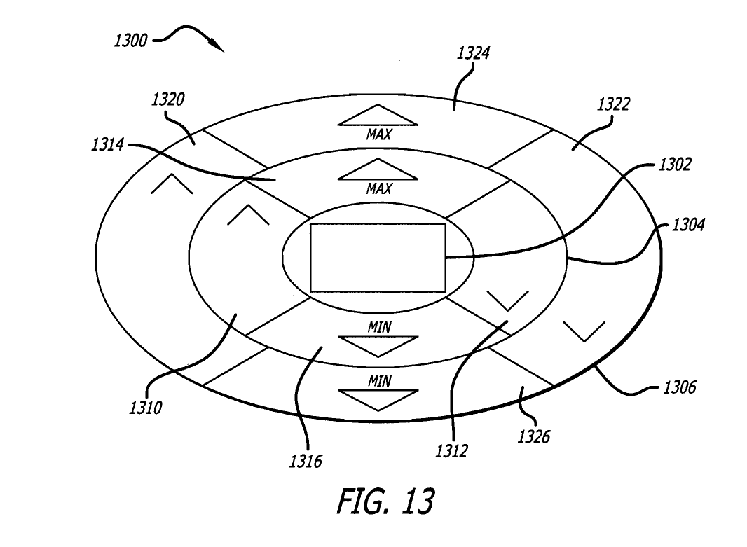

Additionally, in an optional embodiment, the universal button module comprises multiple control or display portions that are moveable relative to one another. In the example embodiment illustrated in FIG. 13, a universal button module 1300 is illustrated. The universal button module 1300 comprises a display 1302, an inner control portion 1304 and an outer control portion 1306. The inner control portion 1304 comprises button portions 1310, 1312, 1314, and 1316. The outer control portion 1306 comprises button portions 1320, 1322, 1324 and 1326.

In one embodiment, the inner control portion 1304 is used to select the number of pay lines to play in a game and the outer control portion 1306 is used to select the number of credits to bet per pay line. In the inner control portion 1304, the button portion 1310 increases the number of pay lines to play and the button portion 1312 decreases the number of pay lines to play. The button portion 1314 is a maximum pay line button for automatically selecting the maximum allowable number of pay lines to play. The button portion 1316 is a minimum pay line button for automatically selecting the minimum permissible number of pay lines to play. In the outer control portion 1306, the outer button portion 1320 increases the number of credits to bet per pay line and the button portion 1322 decreases the number of credits to bet per pay line. The button portion 1324 is a maximum pay line button for automatically selecting the maximum allowable number of credits to bet per pay line. The button portion 1326 is a minimum pay line button for automatically selecting the minimum permissible number of credits to bet per pay line.

The display 1302 can display the data associated with the control portion of the universal button module 1300 being activated. For example, the display 1302 can show the number of credits bet per line for the game when the outer control portion 1306 is activated or in use. Additionally, the display 1302 can show the number of lines to play in a game when the inner control portion 1304 is activated or in use.

In an alternative embodiment, the inner control portion 1304 is used to select the number of credits to bet per pay line and the outer control portion 1306 is used to select the number of pay lines to play in a game. In this alternative embodiment, the button portion 1310 increases the number of credits to bet per pay line and the button portion 1312 decreases the number of credits to bet per pay line. The button portion 1314 is a maximum pay line button for automatically selecting the maximum allowable number of credits to bet per pay line. The button portion 1316 is a minimum pay line button for automatically selecting the minimum permissible number of credits to bet per pay line. In the outer control portion 1306, the button portion 1320 increases the number of pay lines to play and the button portion 1322 decreases the number of pay lines to play. The button portion 1324 is a maximum pay line button for automatically selecting the maximum allowable number of pay lines to play. The button portion 1326 is a minimum pay line button for automatically selecting the minimum permissible number of pay lines to play. The display 1302 shows information associated with the control portion activated or in use.

The universal button module may be used in any environment wherein a button panel is used and it is desirable to add functionality without physically changing the button panel. Fore example, the universal button module may be used on automated teller machines (ATMs) and vending machines.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A gaming machine, comprising:
a cabinet having a game display;
a playing deck;
one or more games having one or more pay lines; and
one or more universal button modules.

2. The gaming machine of claim 1, wherein the universal button module controls the selection of the number of pay lines to play in a game or the number of credits to bet per pay line in a game.

3. The gaming machine of claim 1, wherein the universal button module comprises a first button portion for incrementally increasing the number of pay lines to play or credits to bet per pay line, and a second button portion for incrementally decreasing the number of pay lines to play or credits to bet per pay line.

4. The gaming machine of claim 3, wherein the universal button module further comprises a maximum button portion for automatically selecting a maximum number of pay lines to play or a maximum number of credits to bet per pay line.

5. The gaming machine of claim 3, wherein the universal button module further comprises a minimum button portion for automatically selecting a minimum number of pay lines to play or a minimum number of credits to bet per pay line.

6. The gaming machine of claim 3, wherein the universal button module includes a display.

7. The gaming machine of claim 6, wherein the display outputs information to a game player.

8. The gaming machine of claim 1, wherein one or more universal button modules are positioned on the playing deck.

9. The gaming machine of claim 1, further comprising two universal button modules.

10. The gaming machine of claim 9, wherein the first universal button module controls the selection of the number of pay lines.

11. The gaming machine of claim 9, wherein the second universal button module controls the selection of the number of credits to bet per pay line.

12. The gaming machine of claim 11, wherein the number of credits to bet per pay line is different for one or more pay lines.

13. A universal button module for use in connection with a gaming machine, comprising:
a first button portion for increasing the number of pay lines to play or the number of credits to bet per pay line; and
a second button portion for decreasing the number of pay lines to play or the number of credits to bet per pay line.

14. The universal button module of claim 13, further comprising a display for outputting information.

15. The universal button module of claim 13, the wherein the first button portion increases the number of pay lines to play and the second button portion decreases the number of pay lines to play.

16. The universal button module of claim 15 wherein the universal button module is in communication with a second universal button module, and the second universal button model comprises:
a first button portion for increasing the number of credits to bet per pay line; and
a second button portion for decreasing the number of credits to bet per pay line.

17. The universal button module of claim 16, wherein the second universal button module further comprises a display.

18. The universal button module of claim 16, wherein the number of credits to bet per pay line is different for one or more pay lines.

19. The universal button module of claim 14, wherein the display is a LED display.

20. The universal button module of claim 14, wherein the display is a VFD display.

21. The universal button module of claim 14, further comprising a third button portion for automatically selecting a maximum number of pay lines to play or credits to bet per pay line to be selected.

22. The universal button module of claim 21, further comprising a fourth button portion automatically selecting a minimum number of pay lines to play or credits to bet per pay line to be selected.

23. The universal button module of claim 22, wherein the first, second, third, and fourth button portions are positioned around the display.

24. The universal button module of claim 13, further comprising one or more lights.

25. A universal button module for use in connection with a machine, comprising:
a first button portion for controlling a first function in connection with the machine;
a second button portion for controlling a second function in connection with the machine; and
a display for outputting information.

26. The universal button module of claim 25, wherein the first function of the first button portion counteracts the second function of the second button portion.

27. The universal button module of claim 25, wherein the universal button module is used in connection with a vending machine.

28. The universal button module of claim 25, wherein the universal button module is used in connection with an automated teller machine.

29. The universal button module of claim 25, wherein the universal button module is used in connection with a gaming machine.

30. The universal button module of claim 29, wherein the first function is the increase of the number of pay lines, and the second function is the decrease of the number of pay lines.

31. The universal button module of claim 30, wherein the first button portion controls the increase of the number of pay lines.

32. The universal button module of claim 31, wherein the number of credits to bet is different per pay line.

33. The universal button module of claim 25, wherein the display is a LED display.

34. The universal button module of claim 25, wherein the display is a VFD display.

35. The universal button module of claim 25, wherein the display outputs text information.

36. The universal button module of claim 25, wherein the display outputs promotional information.

37. The universal button module of claim 25, wherein the display outputs player specific information.

38. The universal button module of claim 25, wherein the information output by the display is in the form of animated graphics.

39. The universal button module of claim 25 further comprising lights.
